(19) United States
(12) Patent Application Publication
(10) Pub. No.: US 2016/0356026 A1
(43) Pub. Date: Dec. 8, 2016

(54) RF-SIGNAL-EMITTING VALVE FOR FLOW MONITORING AND LEAK DETECTION

(71) Applicant: Kevin J. Engler, St. Charles, IL (US)

(72) Inventor: Kevin J. Engler, St. Charles, IL (US)

(73) Assignee: Robertshaw Controls Company, Carol Stream, IL (US)

(21) Appl. No.: 14/729,880

(22) Filed: Jun. 3, 2015

(51) Int. Cl. E03B 7/00; F16K 37/00; G01F 15/00

(52) U.S. Cl. CPC E03B 7/003; G01F 15/005; F16K 37/0041; F16K 37/005

(57) ABSTRACT

A valve includes a valve housing with a valve inlet and valve outlet. A valve member is disposed between the valve inlet and valve outlet. The valve member is movable between an open and closed position. The valve has one or more electronic sensors disposed in the valve housing. The one or more electronic sensors may include an electronic flow meter, a temperature sensor, pressure sensor, and/or a position sensor. A wireless RF transmitter is electrically coupled to the one or more electronic sensors. The wireless RF transmitter is configured to wirelessly communicate information from the one or more electronic sensors.

### FIELD OF THE INVENTION

This invention generally relates to water systems and valves used therein.

### BACKGROUND OF THE INVENTION

There has long been need for leak detection in the water supply systems used to serve the common household. Complicated systems to help shut off water for an appliance or full house water system have been developed. However, conventional water supply systems tend to focus on systems to shut off the flow of water once a leak is detected. With the advent of the so-called smart home, it would be desirable to have a water supply system that includes a water valve with the capability to communicate the status of the valve, the fluid flowing through the valve, for example the overall flow of water in the house. Such a water valve could provide significant advantages with respect to the detection and/or prevention of leaks in the water supply system.

Embodiments of the invention provide such a water valve. These and other advantages of the invention, as well as additional inventive features, will be apparent from the description of the invention provided herein.

### BRIEF SUMMARY OF THE INVENTION

In one aspect, embodiments of the invention provide a valve that includes a valve housing with a valve inlet and valve outlet, and a valve member disposed between the valve inlet and valve outlet. The valve member is movable between an open and closed position. The valve has one or more electronic sensors disposed in the valve housing, and a wireless RF transmitter electrically coupled to the one or more electronic sensors. The wireless RF transmitter is configured to wirelessly communicate information from the one or more electronic sensors.

In a particular embodiment, the one or more electronic sensors include a flow meter. The flow meter may be one of a Hall-effect sensor configured to provide a signal to the wireless RF transmitter, and a reed switch configured to provide a signal to the wireless RF transmitter. In other embodiments, the one or more electronic sensors include a temperature sensor. Additionally, the one or more electronic sensors may include a position sensor configured to determine a position of the valve member. Also, the one or more electronic sensors could include a valve inlet pressure sensor and a valve outlet pressure sensor.

In certain embodiments, the wireless RF transmitter is configured to communicate wirelessly with a mobile electronic device, the mobile electronic device including an application that allows the user to receive information from the wireless RF transmitter. In more particular embodiments, the wireless RF transmitter is configured to receive commands from the mobile electronic device, and to transmit the commands to an actuator that controls a position of the valve member. Alternatively, the wireless RF transmitter may be configured to communicate wirelessly with a computer having software that allows the user to receive information from the wireless RF transmitter. More specifically, the wireless RF transmitter may be configured to receive commands from the computer, and to transmit the commands to an actuator that controls a position of the valve member. In a particular embodiment, the wireless RF transmitter is powered by a rechargeable battery. In some embodiments, the communications protocol for the wireless RF transmitter is Bluetooth or ZigBee.

The valve may further comprise an electrically-controlled actuator configured to position the valve member, where the electrically-controlled actuator is coupled to the wireless RF transmitter. The electrically-controlled actuator may be configured to be controlled remotely from a computer or mobile electronic device. In a further embodiment, the computer and mobile electronic device are each programmed to provide an alarm signal to the user when the information from the one or more sensors indicates one of a malfunction of the valve, and a leak in a piping system connected to the valve.

In another aspect, embodiments of the invention provide a valve system that includes a remote electronic device having an electronic display, and a valve. The valve has a valve housing with a valve inlet and valve outlet, and a valve member disposed between the valve inlet and valve outlet. In some embodiment, the valve member is movable between an open and closed position. The valve includes one or more electronic sensors disposed in the valve housing, a wireless RF transmitter electrically coupled to the one or more electronic sensors, and configured to wirelessly communicate information from the one or more electronic sensors. The remote electronic device is configured to receive, via the wireless RF transmitter, the information from the one or more electronic sensors, and to display the information on the electronic display.

In certain embodiments, the remote electronic device is one of a desktop PC, a laptop PC, a notebook PC, a tablet computer, and a smart phone. In a particular embodiment, the valve is a check valve of a sump pump, and the one or more electronic sensors include a flow meter. The valve may further comprise an electrically-controlled actuator configured to position the valve member, where the electrically-controlled actuator is coupled to the wireless RF transmitter. Further, the remote electronic device may be programmed to control the electrically-controlled actuator via the wireless RF transmitter. Additionally, the remote electronic device may be programmed to automatically close the valve when the information from the one or more electronic sensors indicates that there is a malfunction in the valve, or that there is a leak in a piping system connected to the valve. In other embodiments, the remote electronic device is programmed to automatically provide an alarm signal when the information from the one or more electronic sensors indicates that there is a malfunction in the valve, or that there is a leak in a piping system connected to the valve.

In a particular embodiment, the valve is a supply valve for a water supply system, and wherein the remote electronic device is programmed to cause the supply valve to close when the one or more sensors indicate a leak in the water supply system. The one or more electronic sensors may be one of a flow meter, a valve inlet pressure sensor, a valve outlet pressure sensor, a temperature sensor, and a position sensor configured to determine a position of the valve member. Alternatively, the one or more electronic sensors may be one of a Hall-effect sensor flow meter configured to provide a signal to the wireless RF transmitter, and a reed switch flow meter configured to provide a signal to the wireless RF transmitter.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic cross-sectional view of an RF signal-emitting valve, according to an embodiment of the invention;

FIG. 2 is a schematic diagram showing an exemplary valve system with the RF signal-emitting valve of FIG. 1, according to an embodiment of the invention; and

FIG. 3 is a schematic diagram showing a sump pump with the RF signal-emitting valve of FIG. 1, according to an embodiment of the invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

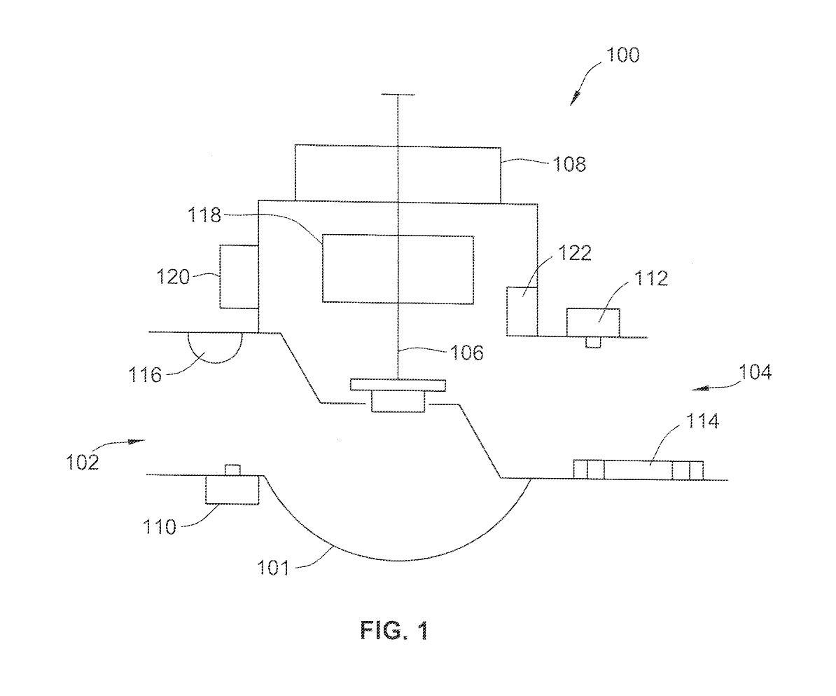

FIG. 1 is a schematic cross-sectional view of an RF signal-emitting valve 100, according to an embodiment of the invention. The RF signal-emitting valve 100 has a valve housing 101, an inlet 102 and an outlet 104. A valve member 106 is positionable between an open position and a closed position. The valve member 106 is positioned by an electric actuator 108.

In general, the RF signal-emitting valve 100 includes at least one electronic sensor. In the particular embodiment of FIG. 1, the RF signal-emitting valve 100 includes multiple electronic sensors. An inlet pressure sensor 110, configured to measure fluid pressure, is located at the inlet 102, while outlet pressure sensor 112 is located at the outlet 104. A flow meter 114, configured to measure the flow rate of a fluid flowing through the valve 100, is also positioned proximate the outlet 104. A temperature sensor 116, configured to measure a temperature of fluid flowing through the valve 100. A position sensor 118, configured to sense a position of the valve member 106, is located proximate the valve member 106. The position sensor 118 may be a linear variable differential transformer, for example, though other types of electronic position sensors including, but not limited to, capacitive displacement sensors, inductive non-contact displacement sensors, and Hall-effect sensors may also be used. In particular embodiments of the invention, the electric actuator 108 and the aforementioned electronic sensors may be powered by a battery 120, such as a lithium-ion battery for example. The battery 120 may be attached to an exterior surface of the valve housing 101. In other embodiments, the electric actuator 108 and electronic sensors may be powered via an external power supply, such as utility-supplied power.

The electric actuator 108 and the aforementioned electronic sensors are connected to a wireless RF signal emitter 122, which is configured to receive information from each of the electronic sensors, and to wirelessly transmit that information to a remote electronic device, such as a desktop or laptop personal computer, tablet computer, or smart phone. The remote electronic device has a display and is programmed such that a user can monitor a status of the valve 100, or monitor various parameters of a fluid flowing through the valve 100. In certain embodiments, the user can send commands via the remote electronic device to the electric actuator 108 through the wireless RF signal emitter 122, allowing remote control of the valve member 106.

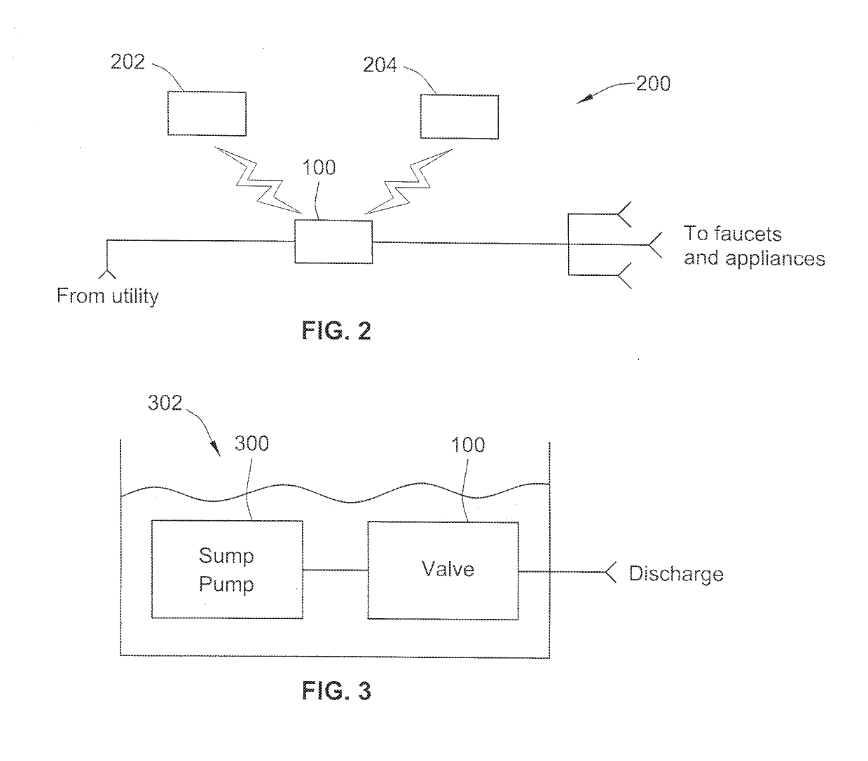

FIG. 2 is a schematic diagram of a valve system 200 that includes the RF signal-emitting valve 100, according to an embodiment of the invention. The valve system 200 of FIG. 2 is used in a water supply system such as would be used to supply water to a residence. In the embodiment shown, water from a utility flows through the RF signal-emitting valve 100 to appliances or faucets throughout the residence. The RF signal-emitting valve 100 wirelessly communicates with a remote electronic device such as a personal computer 202 (desktop, laptop, notebook, etc.) or mobile electronic device 204, such as a tablet computer or a smart phone. The personal computer 202 includes specific hardware and software to facilitate two-way communication with the RF signal-emitting valve 100, and to facilitate the display of information received from the RF signal-emitting valve 100 with information from the one or more electronic sensors. Similarly, the mobile electronic device 204 includes an application to facilitate two-way wireless communication with the RF signal-emitting valve 100, and to facilitate the display of information received from the RF signal-emitting valve 100 with information from the one or more electronic sensors. The personal computer 202 and mobile electronic device 204 are also programmed to transmit commands to the RF signal-emitting valve 100, allowing the user to remotely control functions, such as opening and closing, of the RF signal-emitting valve 100. The communication protocol used by the RF signal-emitting valve 100 may be one of the Bluetooth and ZigBee protocols, though other suitable communication protocols may be used.

In certain embodiments, the user of the remote electronic device will be programmed to provide a visual and/or digital display of the parameters determined by the one or more electronic sensors. Consequently, the user is able to determine if the fluid flow through the valve is above normal, below normal, or at the level expected. Depending on the reading, the user can be alerted to a possible leak in the piping system connected to the RF signal-emitting valve 100, or alerted to a malfunction in the RF signal-emitting valve 100. In particular embodiment, the remote electronic device is programmed to alert the user, via an audio or visual alarm for example, when the parameters received, from the RF signal-emitting valve 100, are outside of a predetermined threshold range, thus indication a possible leak in the aforementioned piping system, or of a malfunction in the valve 100. In a more particular embodiment, the remote electronic device is programmed to automatically command the electric actuator 108 to close the RF signal-emitting valve 100, when the parameters received, from the RF signal-emitting valve 100, are indicative of a possible leak in the aforementioned piping system, or of a malfunction in the valve 100.

FIG. 3 is a schematic diagram showing a sump pump 300 that includes the RF signal-emitting valve 100, according to an embodiment of the invention. The RF signal-emitting valve 100 is located inside of the sump 302 and connected to the sump pump 300. Thus, the one or more electronic sensors in the RF signal-emitting valve 100 are indicative of a flow through the valve 100, and, therefore, operation of the sump pump 300. The user is thus able to remotely monitor the operation of the sump pump 300 from the display of the remote electronic device. Additionally, the remote electronic device may be programmed to automatically alert the user, via an audio or visual alarm for example, when the information received from the RF signal-emitting valve 100 is indicative of a leak in the piping system attached to the sump pump 300, or of a malfunction in the sump pump 300.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A valve comprising:
a valve housing with a valve inlet and valve outlet;
a valve member disposed between the valve inlet and valve outlet, the valve member movable between an open and closed position;
one or more electronic sensors disposed in the valve housing;
a wireless RF transmitter electrically coupled to the one or more electronic sensors, and configured to wirelessly communicate information from the one or more electronic sensors.

2. The valve of claim 1, wherein the one or more electronic sensors includes a flow meter.

3. The valve of claim 2, wherein the flow meter is one of a Hall-effect sensor configured to provide a signal to the wireless RF transmitter, and a reed switch configured to provide a signal to the wireless RF transmitter.

4. The valve of claim 1, wherein the one or more electronic sensors includes a temperature sensor.

5. The valve of claim 1, wherein the one or more electronic sensors includes a position sensor configured to determine a position of the valve member.

6. The valve of claim 5, wherein the position sensor is one of a linear variable differential transformer, a capacitive displacement sensor, an inductive non-contact displacement sensor, and a Hall-effect sensor.

7. The valve of claim 1, wherein the one or more electronic sensors includes a valve inlet pressure sensor and a valve outlet pressure sensor.

8. The valve of claim 1, wherein the wireless RF transmitter is configured to communicate wirelessly with a mobile electronic device, the mobile electronic device including an application that allows the user to receive information from the wireless RF transmitter.

9. The valve of claim 8, wherein the wireless RF transmitter is configured to receive commands from the mobile electronic device, and to transmit the commands to an actuator that controls a position of the valve member.

10. The valve of claim 1, wherein the wireless RF transmitter is configured to communicate wirelessly with a computer having software that allows the user to receive information from the wireless RF transmitter.

11. The valve of claim 10, wherein the wireless RF transmitter is configured to receive commands from the computer, and to transmit the commands to an actuator that controls a position of the valve member.

12. The valve of claim 1, further comprising an electrically-controlled actuator configured to position the valve member, the electrically-controlled actuator being coupled to the wireless RF transmitter.

13. The valve of claim 12, wherein the electrically-controlled actuator is configured to be controlled remotely from a computer or mobile electronic device.

14. The valve of claim 13, wherein the computer and mobile electronic device are each programmed to provide an alarm signal to the user when the information from the one or more sensors indicates one of a malfunction of the valve, and a leak in a piping system connected to the valve.

15. The valve of claim 1, wherein the communications protocol for the wireless RF transmitter is Bluetooth or ZigBee.

16. The valve of claim 1, wherein the wireless RF transmitter is powered by a rechargeable battery.

17. A valve system comprising:
a remote electronic device having an electronic display;
a valve comprising:
a valve housing with a valve inlet and valve outlet;
a valve member disposed between the valve inlet and valve outlet, the valve member movable between an open and closed position;
one or more electronic sensors disposed in the valve housing;
a wireless RF transmitter electrically coupled to the one or more electronic sensors, and configured to wirelessly communicate information from the one or more electronic sensors;
wherein the remote electronic device is configured to receive, via the wireless RF transmitter, the information from the one or more electronic sensors, and to display the information on the electronic display.

18. The valve system of claim 17, wherein the remote electronic device is one of a desktop PC, a laptop PC, a notebook PC, a tablet computer, and a smart phone.

19. The valve system of claim 17, wherein the valve is a check valve of a sump pump, and wherein the one or more electronic sensors comprise a flow meter.

20. The valve system of claim 17, wherein the valve further comprises an electrically-controlled actuator configured to position the valve member, the electrically-controlled actuator being coupled to the wireless RF transmitter.

21. The valve system of claim 20, wherein the remote electronic device is programmed to control the electrically-controlled actuator via the wireless RF transmitter.

22. The valve system of claim 21, wherein the remote electronic device is programmed to automatically close the valve when the information from the one or more electronic sensors indicates that there is a malfunction in the valve, or that there is a leak in a piping system connected to the valve.

23. The valve system of claim 20, wherein the remote electronic device is programmed to automatically provide an alarm signal when the information from the one or more electronic sensors indicates that there is a malfunction in the valve, or that there is a leak in a piping system connected to the valve.

24. The valve system of claim 20, wherein the valve is a supply valve for a water supply system, and wherein the remote electronic device is programmed to cause the supply valve to close when the one or more sensors indicate a leak in the water supply system.

25. The valve system of claim 17, wherein the one or more electronic sensors comprises one of a flow meter, a valve inlet pressure sensor, a valve outlet pressure sensor, a temperature sensor, and a position sensor configured to determine a position of the valve member.

26. The valve system of claim 17, wherein the one or more electronic sensors comprises one of a Hall-effect sensor flow meter configured to provide a signal to the wireless RF transmitter, and a reed switch flow meter configured to provide a signal to the wireless RF transmitter.
